(19) United States
(12) Patent Application Publication
(10) Pub. No.: US 2022/0051156 A1
(43) Pub. Date: Feb. 17, 2022

(54) ROADSIDE ASSISTANCE FOR AUTONOMOUS VEHICLES

(71) Applicant: Waymo LLC, Mountain View, CA (US)

(72) Inventors: Atul Kumar, Palo Alto, CA (US); Ganesh Balachandran, Mountain View, CA (US); Peter Cheng, San Francisco, CA (US)

(21) Appl. No.: 16/990,552

(22) Filed: Aug. 11, 2020

(51) Int. Cl. G06Q 10/06; G06Q 10/00; G08G 1/00; G07C 5/00; G07C 5/08

(52) U.S. Cl. CPC G06Q 10/06315; G06Q 10/20; G08G 1/205; G07C 5/008; G08G 1/22; G07C 5/006; G07C 5/0816; G08G 1/202

(57) ABSTRACT

Aspects of the disclosure relate to determining how to distribute roadside assistance vehicles within a service area for a fleet of autonomous vehicles. As one example, the service area may be divided into a grid including a plurality of cells. For each cell of the plurality of cells, a likelihood that a vehicle of the fleet will require roadside assistance may be determined. A distribution of the roadside assistance vehicles may be determined by assigning the roadside assistance vehicles to ones of the plurality of cells based on the likelihoods.

### BACKGROUND

Autonomous vehicles, for instance, vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location. However, in some situations, autonomous vehicles may no longer be able to make forward progress towards a destination of the vehicle and thus may require human intervention or assistance. In addition, such vehicles may not have a “driver” who is able to take control of the vehicle and/or address the reason why the vehicle requires assistance.

### BRIEF DESCRIPTION OF THE DRAWINGS

FIG. 1 is a functional diagram of an example vehicle in accordance with an exemplary embodiment.

FIG. 2 is an example diagram of a vehicle in accordance with aspects of the disclosure.

FIG. 3 is an example pictorial diagram of a system in accordance with aspects of the disclosure.

FIG. 4 is an example functional diagram of a system in accordance with aspects of the disclosure.

FIG. 5 is an example road map in accordance with aspects of the disclosure.

FIG. 6 is an example road map and service area in accordance with aspects of the disclosure.

FIGS. 7A-7C are example road maps, service areas, and grids of cells in accordance with aspects of the disclosure.

FIG. 8 is an example of a distribution of roadside assistance vehicles for a grid of cells in accordance with aspects of the disclosure.

FIG. 9 is an example flow diagram in accordance with aspects of the disclosure.

### SUMMARY

Aspects of the disclosure provide a method of determining how to distribute roadside assistance vehicles within a service area for a fleet of autonomous vehicles. The method includes dividing, by one or more processors, the service area into a grid including a plurality of cells; for each cell of the plurality of cells, determining, by the one or more processors, a likelihood that a vehicle of the fleet will require roadside assistance; and determining, by the one or more processors, a distribution of the roadside assistance vehicles by assigning the roadside assistance vehicles to ones of the plurality of cells based on the likelihoods.

In one example, dividing the service area into the grid includes using S2 cells. In this example, the method also includes selecting a level of the S2 cells based on a number of the roadside assistance vehicles. In another example, each cell of the plurality of cells has a same size. In another example, the plurality of cells includes two or more cells of different sizes. In another example, the method also includes merging adjacent cells of the grid into a larger cell based on historical data identifying where autonomous vehicles have previously required assistance. In another example, the method also includes dividing a cell of the grid into two or more smaller cells based on historical data identifying where autonomous vehicles have previously required assistance. In another example, the method also includes in response to an occurrence of an event: dividing, by one or more processors, the service area into a second grid including a second plurality of cells; for each cell of the second plurality of cells, determining, by the one or more processors, a second likelihood that a vehicle of the fleet will require roadside assistance; and determining, by the one or more processors, a second distribution of the roadside assistance vehicles by assigning the roadside assistance vehicles to ones of the second plurality of cells based on the second likelihoods. In this example, the event is one or more vehicles of the fleet receiving a software update. Alternatively, the event is a change to map information, wherein the map information is further used to determine the likelihoods and the second likelihoods. In another example, determining the likelihoods includes using a model to predict the likelihoods. In this example, determining the likelihoods includes inputting map information for each cell into the model. In addition or alternatively, determining the likelihoods includes inputting traffic information for each cell into the model. In addition or alternatively, determining the likelihoods includes inputting time of day information into the model. In another example, determining the likelihoods is based on miles driven by autonomous vehicles within a predetermined period of time. In another example, determining the distribution includes assigning the roadside assistance vehicles to the plurality of cells in order of those having the highest likelihoods. In another example, the method also includes, in response to occurrence of an event: for each cell of the plurality of cells, determining, by the one or more processors, an updated likelihood that a vehicle of the fleet will require roadside assistance; and determining an updated distribution of the roadside assistance vehicles by assigning the roadside assistance vehicles to ones of the plurality of cells based on the updated likelihoods. In another example, assigning the roadside assistance vehicles to ones of the plurality of cells based on the likelihoods includes determining strategic locations within the ones, where a strategic location is one from which all other locations within a cell can be reached by a roadside assistance vehicle quickest. In another example, the method also includes, as an autonomous vehicle of the fleet enters a cell of the plurality of cells, binding a roadside assistance vehicle assigned to that cell to the vehicle such that the roadside assistance vehicle will provide assistance if the autonomous vehicle requests roadside assistance. In another example, the method also includes, when an autonomous vehicle of the fleet requests assistance within a cell of the plurality of cells, binding the roadside assistance vehicle assigned to that cell to the vehicle such that the roadside assistance vehicle will provide roadside assistance to the autonomous vehicle.

### DETAILED DESCRIPTION

### Overview

The technology relates to enabling roadside assistance for autonomous vehicles, especially in situations in which such vehicles may no longer be able to make forward progress towards a destination of the vehicle and thus may require human intervention or assistance. In addition, such vehicles may not have a “driver” who is able to take control of the vehicle and/or address the reason why the vehicle requires assistance. As used herein, the phrases “requires human intervention” and “requires assistance” may refer to situations in which a vehicle's computing device or operator decides that the optimal action is to bring the vehicle to a stop despite the ability to continue making forward progress, situations where a hardware or software issue may cause the vehicle to come to a stop, or a combination thereof.

As one instance, the computing devices of a vehicle in the autonomous driving mode may be unable to make forward progress towards its destination. For instance, a vehicle's computing devices may detect a problem that may inhibit forward progress of a vehicle, such as a stationary obstacle blocking a portion of the roadway or low tire pressure which may be caused, for example, due to a slow leak or puncture in a tire of the vehicle. In response, the computing devices may stop the vehicle immediately in a lane or by pulling the vehicle over depending upon the situation. At this point in time, the vehicle would require assistance. As another instance, if the vehicle's computing devices detect a software or hardware issue with any of the features of the autonomous control system, the vehicle may enter a “fallback state” or a mode of degraded operation. In such instances, the vehicle's computing devices may bring the vehicle to a stop again causing the vehicle to require assistance. As another instance, if the computing devices detect input of a particular force at certain user inputs of the vehicle (e.g. brake pedal, accelerator pedal, steering wheel, pullover button, emergency stopping button etc.), devices may stop the vehicle (e.g. pull the vehicle over or stop immediately), causing the vehicle to require assistance. As another instance, the vehicle's computing devices receive instructions from a remote computing device to stop or pull over. For example, in certain circumstances, a human operator may determine that it is no longer safe or practical for a vehicle to continue operating in an autonomous driving mode. This may occur for any number of reasons, such as if the passenger requests assistance (via a user input of the vehicle and/or his or her mobile phone), etc.

Typical roadside assistance may be provided by first responders or third party provides. However, summoning first responders may be an inappropriate use of such resources when there is no danger to humans or traffic. In addition, third party responders may not be equipped to resolve issues faced by autonomous vehicles and can be cost prohibitive when used for a fleet of autonomous vehicles.

Because the number of roadside assistance vehicles is likely to be much less than the number of autonomous vehicles in a fleet of autonomous vehicles, and as such, assigning roadside assistance vehicles to one or a specific set of vehicles may be unrealistic and costly. Other approaches may include a need-based dispatching of roadside assistance vehicles. However, this approach may result in long and unpredictable wait times.

To address these deficiencies, roadside assistance vehicles may be assigned to predetermined areas. In order to do so, a service area, which defines where the autonomous vehicles of the fleet are able to provide transportation services, may be divided into a grid of cells. For each cell, the need for roadside assistance may be predicted. This “need” may correspond to a likelihood that one or more vehicles will require assistance at any given point in time in each cell. This likelihood may be determined using a model trained using input from miles driven by the autonomous vehicles of the fleet or over some period of time that include both examples of vehicles requiring assistance and vehicles not requiring assistance.

In order to make the model useful for areas where vehicles have not previously visited, the training inputs may include, for example, map, traffic information, time of day, weather conditions, as well as other information describing the driving environment in the miles driven. In this regard, for each example of a vehicle requiring assistance or a vehicle not requiring assistance used as training output, the model is provided with the context in the vehicle was driving. As a result, when map information, traffic information, time of day, weather conditions, for a particular cell of a grid is input into the model, the model may provide an estimation of how likely one or more vehicles is to require assistance within that cell. In other words, the model may predict how likely one or more vehicles of the fleet is to require assistance under various conditions in a given cell. This prediction may be used to drive the optimal distribution and placement of roadside assistance vehicles in order to enable the roadside assistance vehicles to assist the autonomous vehicles with predictable arrival and service time while also reducing costs.

The distribution information, the trip information, and a notification that a vehicle requires assistance are sent to the human operators or technicians of the roadside assistance vehicles. Once the roadside assistance vehicles are assigned to (e.g. distributed) cells and are driving or stopped within those cells, the roadside assistance vehicles may provide roadside assistance services to autonomous vehicles of the fleet as they enter different cells. This may be done automatically through an application that can be accessed using a mobile computing device of the technician. When the technician has the application open, he or she may receive notifications that a vehicle requires assistance and provide such assistance.

The technology relates to optimizing the distribution of roadside assistance vehicles for responding to requests for assistance by autonomous vehicles. The features described herein may provide a more predictable, resilient, scalable, and cost-effective distribution of roadside assistance vehicles without compromising safety. In addition, the model may enable the distribution to be dynamic and adjustable depending upon the number of available roadside assistance vehicles and how likely autonomous vehicles are to require assistance at any given location within a service area.

### Example Systems

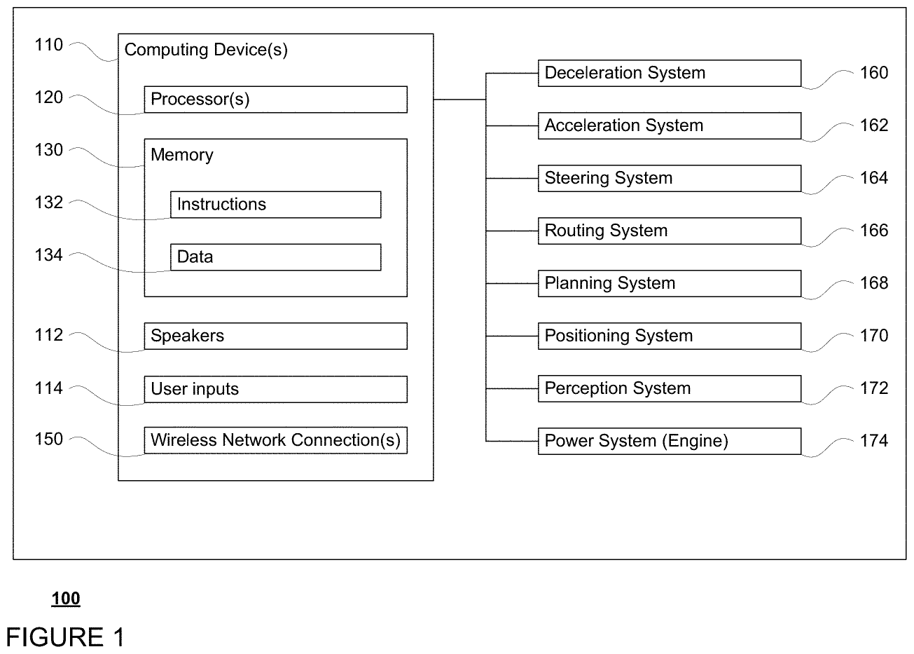

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

The computing devices 110 may also be connected to one or more speakers 112 as well as one or more user inputs 114. The speakers may enable the computing devices to provide audible messages and information, such as the alerts described herein, to occupants of the vehicle, including a driver. In some instances, the computing devices may be connected to one or more vibration devices configured to vibrate based on a signal from the computing devices in order to provide haptic feedback to the driver and/or any other occupants of the vehicle. As an example, a vibration device may consist of a vibration motor or one or more linear resonant actuators placed either below or behind one or more occupants of the vehicle, such as embedded into one or more seats of the vehicle.

The user input may include a button, touchscreen, or other devices that may enable an occupant of the vehicle, such as a driver, to provide input to the computing devices 110 as described herein. As an example, the button or an option on the touchscreen may be specifically designed to cause a transition from the autonomous driving mode to the manual driving mode or the semi-autonomous driving mode.

In one aspect the computing devices 110 may be part of an autonomous control system capable of communicating with various components of the vehicle in order to control the vehicle in an autonomous driving mode. For example, returning to FIG. 1, the computing devices 110 may be in communication with various systems of vehicle 100, such as deceleration system 160, acceleration system 162, steering system 164, routing system 166, planning system 168, positioning system 170, and perception system 172 in order to control the movement, speed, etc. of vehicle 100 in accordance with the instructions 132 of memory 130 in the autonomous driving mode. In this regard, each of these systems may de one or more processors, memory, data and instructions. Such processors, memories, instructions and data may be configured similarly to one or more processors 120, memory 130, instructions 132, and data 134 of computing device 110.

As an example, computing devices 110 may interact with deceleration system 160 and acceleration system 162 in order to control the speed of the vehicle. Similarly, steering system 164 may be used by computing devices 110 in order to control the direction of vehicle 100. For example, if vehicle 100 is configured for use on a road, such as a car or truck, the steering system may include components to control the angle of wheels to turn the vehicle.

Planning system 168 may be used by computing devices 110 in order to determine and follow a route generated by a routing system 166 to a location. For instance, the routing system 166 may use map information to determine a route from a current location of the vehicle to a drop off location. The planning system 168 may periodically generate trajectories, or short-term plans for controlling the vehicle for some period of time into the future, in order to follow the route (a current route of the vehicle) to the destination. In this regard, the planning system 168, routing system 166, and/or data 134 may store detailed map information, e.g., highly detailed maps identifying the shape and elevation of roadways, lane lines, intersections, crosswalks, speed limits, traffic signals, buildings, signs, real time traffic information, vegetation, or other such objects and information. In addition, the map information may identify area types such as constructions zones, school zones, residential areas, parking lots, etc.

The map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features. While the map information may be an image-based map, the map information need not be entirely image based (for example, raster). For example, the map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

Positioning system 170 may be used by computing devices 110 in order to determine the vehicle's relative or absolute position on a map and/or on the earth. The positioning system 170 may also include a GPS receiver to determine the device's latitude, longitude and/or altitude position relative to the Earth. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The positioning system 170 may also include other devices in communication with the computing devices of the computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by the computing devices of the computing devices 110. In the case where the vehicle is a passenger vehicle such as a minivan, the minivan may include a laser or other sensors mounted on the roof or other convenient location.

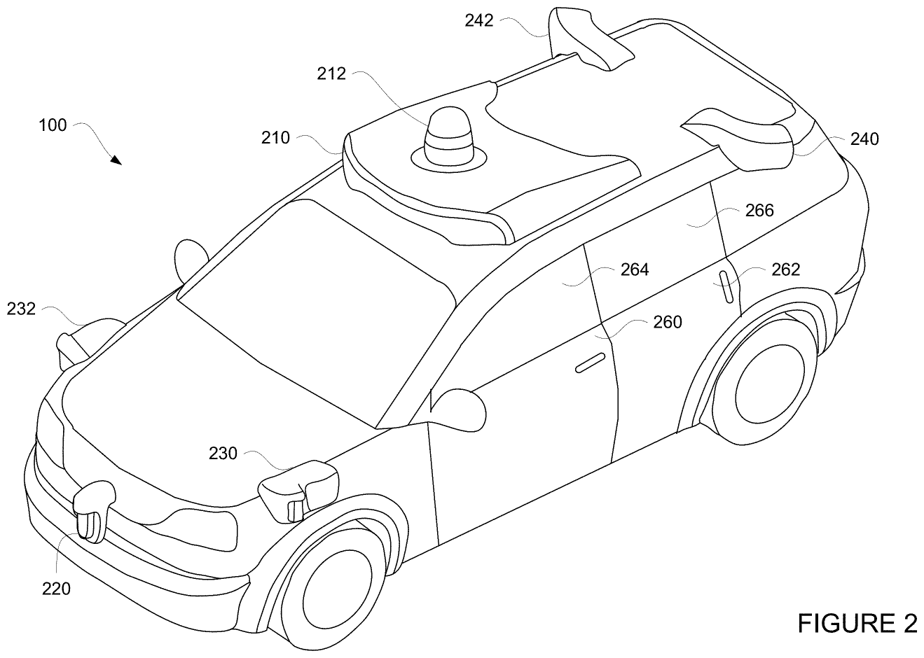

For instance, FIG. 2 is an example external view of vehicle 100. In this example, roof-top housing 210 and dome housing 212 may include a LIDAR sensor as well as various cameras and radar units. In addition, housing 220 located at the front end of vehicle 100 and housings 230, 232 on the driver's and passenger's sides of the vehicle may each store a LIDAR sensor. For example, housing 230 is located in front of doors 260, 262 which also include windows 264, 266. Vehicle 100 also includes housings 240, 242 for radar units and/or cameras also located on the roof of vehicle 100. Additional radar units and cameras (not shown) may be located at the front and rear ends of vehicle 100 and/or on other positions along the roof or roof-top housing 210.

The computing devices 110 may be capable of communicating with various components of the vehicle in order to control the movement of vehicle 100 according to primary vehicle control code of memory of the computing devices 110. For example, returning to FIG. 1, the computing devices 110 may include various computing devices in communication with various systems of vehicle 100, such as deceleration system 160, acceleration system 162, steering system 164, routing system 166, planning system 168, positioning system 170, perception system 172, and power system 174 (i.e. the vehicle's engine or motor) in order to control the movement, speed, etc. of vehicle 100 in accordance with the instructions 132 of memory 130.

The various systems of the vehicle may function using autonomous vehicle control software in order to determine how to and to control the vehicle. As an example, a perception system software module of the perception system 172 may use sensor data generated by one or more sensors of an autonomous vehicle, such as cameras, LIDAR sensors, radar units, sonar units, etc., to detect and identify objects and their features. These features may include location, type, heading, orientation, speed, acceleration, change in acceleration, size, shape, etc. In some instances, features may be input into a behavior prediction system software module which uses various behavior models based on object type to output a predicted future behavior for a detected object.

In other instances, the features may be put into one or more detection system software modules, such as a traffic light detection system software module configured to detect the states of known traffic signals, a school bus detection system software module configured to detect school busses, construction zone detection system software module configured to detect construction zones, a detection system software module configured to detect one or more persons (e.g. pedestrians) directing traffic, a traffic accident detection system software module configured to detect a traffic accident, an emergency vehicle detection system configured to detect emergency vehicles, etc. Each of these detection system software modules may input sensor data generated by the perception system 172 and/or one or more sensors (and in some instances, map information for an area around the vehicle) into various models which may output a likelihood of a certain traffic light state, a likelihood of an object being a school bus, an area of a construction zone, a likelihood of an object being a person directing traffic, an area of a traffic accident, a likelihood of an object being an emergency vehicle, etc., respectively.

Detected objects, predicted future behaviors, various likelihoods from detection system software modules, the map information identifying the vehicle's environment, position information from the positioning system 170 identifying the location and orientation of the vehicle, a destination for the vehicle as well as feedback from various other systems of the vehicle may be input into a planning system software module of the planning system 168. The planning system may use this input to generate trajectories for the vehicle to follow for some brief period of time into the future based on a current route of the vehicle generated by a routing module of the routing system 166. A control system software module of the computing devices 110 may be configured to control movement of the vehicle, for instance by controlling braking, acceleration and steering of the vehicle, in order to follow a trajectory.

Computing devices 110 may also include one or more wireless network connections 150 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

The computing devices 110 may control the vehicle in an autonomous driving mode by controlling various components. For instance, by way of example, the computing devices 110 may navigate the vehicle to a destination location completely autonomously using data from the detailed map information and planning system 168. The computing devices 110 may use the positioning system 170 to determine the vehicle's location and perception system 172 to detect and respond to objects when needed to reach the location safely. Again, in order to do so, computing device 110 may generate trajectories and cause the vehicle to follow these trajectories, for instance, by causing the vehicle to accelerate (e.g., by supplying fuel or other energy to the engine or power system 174 by acceleration system 162), decelerate (e.g., by decreasing the fuel supplied to the engine or power system 174, changing gears, and/or by applying brakes by deceleration system 160), change direction (e.g., by turning the front or rear wheels of vehicle 100 by steering system 164), and signal such changes (e.g. by using turn signals). Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

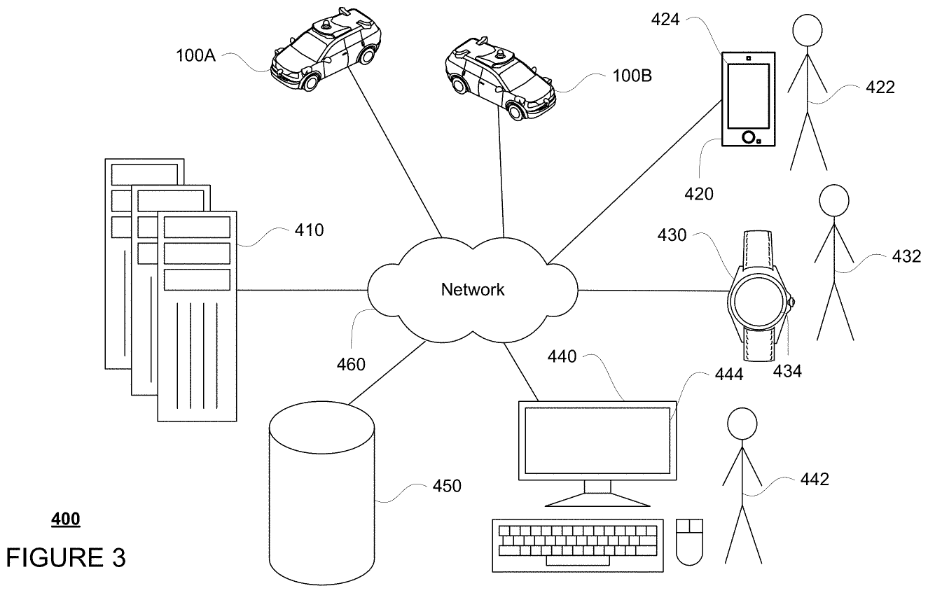

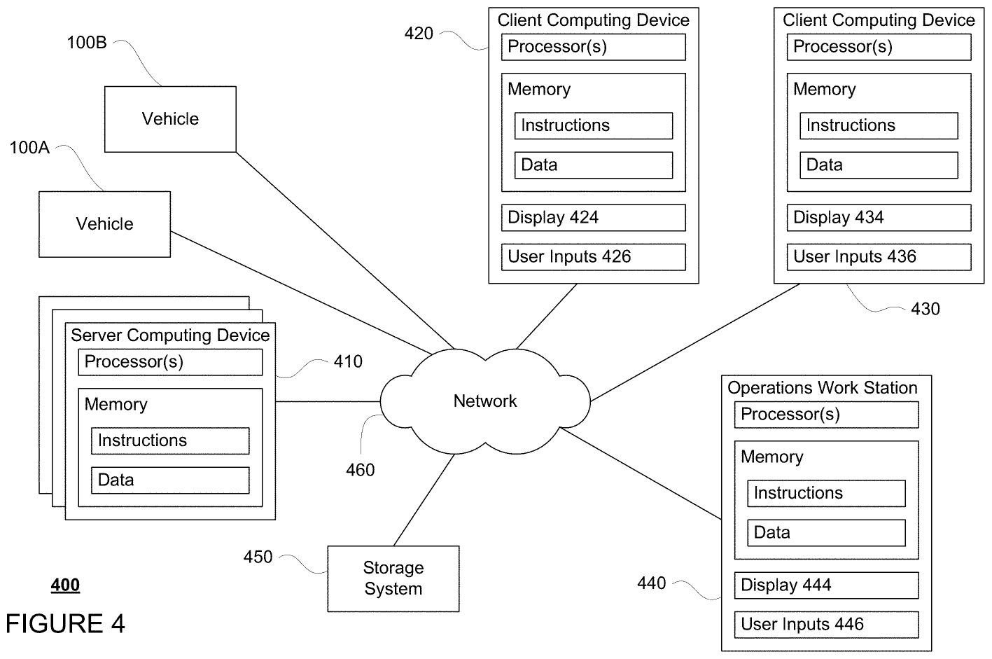

Computing device 110 of vehicle 100 may also receive or transfer information to and from other computing devices, such as those computing devices that are a part of the transportation service as well as other computing devices. FIGS. 3 and 4 are pictorial and functional diagrams, respectively, of an example system 400 that includes a plurality of computing devices 410, 420, 430, 440 and a storage system 450 connected via a network 460. System 400 also includes vehicle 100, and vehicles 100A, 100B which may be configured the same as or similarly to vehicle 100. Although only a few vehicles and computing devices are depicted for simplicity, a typical system may include significantly more.

As shown in FIG. 4, each of computing devices 410, 420, 430, 440 may include one or more processors, memory, instructions and data. Such processors, memories, data and instructions may be configured similarly to one or more processors 120, memory 130, instructions 132 and data 134 of computing device 110.

The network 460, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of vehicle 100 or a similar computing device of vehicle 100A as well as computing devices 420, 430, 440 via the network 460. For example, vehicles 100, 100A, may be a part of a fleet of vehicles that can be dispatched by server computing devices to various locations. In this regard, the server computing devices 410 may function as a validation computing system which can be used to validate autonomous control software which vehicles such as vehicle 100 and vehicle 100A may use to operate in an autonomous driving mode. In addition, server computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 4, each client computing device 420, 430, 440 may be a personal computing device intended for use by a user 422, 432, 442, and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touchscreen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430, and 440 may each comprise a full-sized personal computing device, they may alternatively comprise client computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, depicted as a smart watch as shown in FIG. 4. As an example the user may input information using a small keyboard, a keypad, microphone, using visual signals with a camera, or a touch screen.

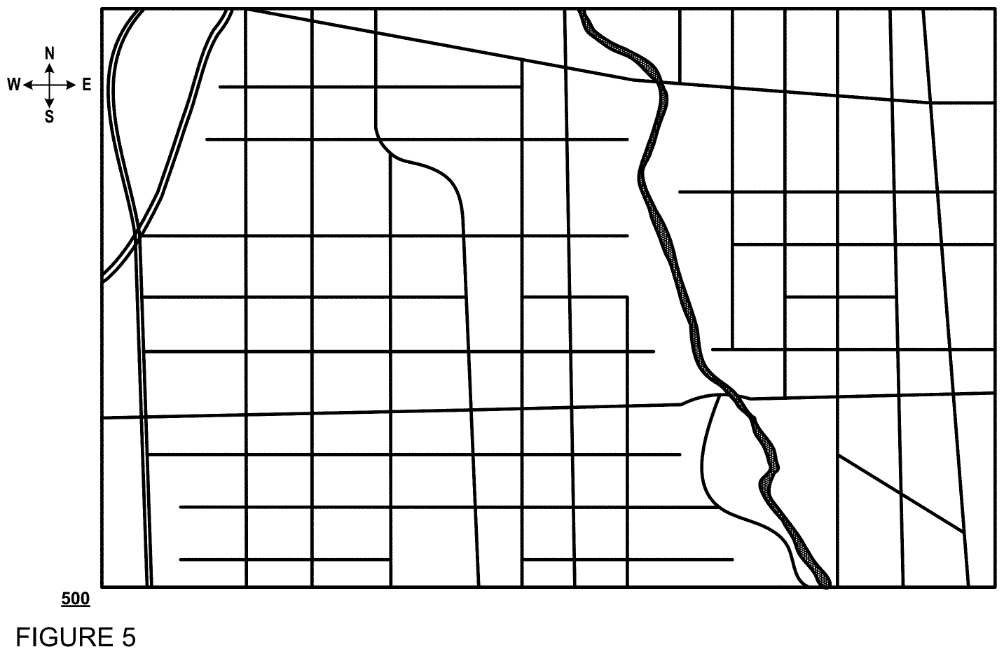

In some examples, client computing device 420 may be a mobile phone used by a technician as discussed further below. In other words, user 422 may represent a technician. In addition, client communication device 430 may represent a smart watch for a passenger of a vehicle. In other words, user 432 may represent a passenger. The client communication device 430 may represent a workstation for an operations person, for example, someone who may provide remote assistance to a vehicle and/or a passenger. In other words, user 442 may represent an operations person. Although only a single technician, passenger, and operations person are shown in FIGS. 4 and 5, any number of such technicians, passengers, and operations personnel (as well as their respective client computing devices) may be included in a typical system. Moreover, although this client computing devices are depicted as a mobile phone, a smart watch, and a workstation, respectively, such devices used by technicians may include various types of personal computing devices such as laptops, netbooks, tablet computers, etc.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 4 and 5, and/or may be directly connected to or incorporated into any of the computing devices 110, 410, 420, 430, 440, etc.

Storage system 450 may store various types of information as described in more detail below. This information stored in the storage system 450 may be retrieved or otherwise accessed by a server computing device, such as one or more server computing devices 410, in order to perform some or all of the features described herein. For example, as described in further detail below, the one or more server computing devices may also track the progress of vehicles of a fleet of vehicles. In this regard, the storage system may store the state of vehicles before, during, and after a service interruption (e.g. a vehicle requires assistance).

The storage system 450 may also store logged data about the locations and trips taken by vehicles of the fleet in the past as well as any requests for assistance. In addition, the storage system 450 may store the aforementioned map information, historical weather information, traffic conditions, models and model parameter values, as well as various representations of geographic areas defined by S2 cells at one or more levels, as well as service area maps and other information discussed below. The S2 cells may be used to represent areas of a curved surface such as the Earth at different levels of granularity (e.g. levels 0 to 30, level 0 having the largest average cell size and level 30 having the smallest average cell size). In this regard, each S2 cell represents a region and corresponding visual representation of that region, e.g. a map tile.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

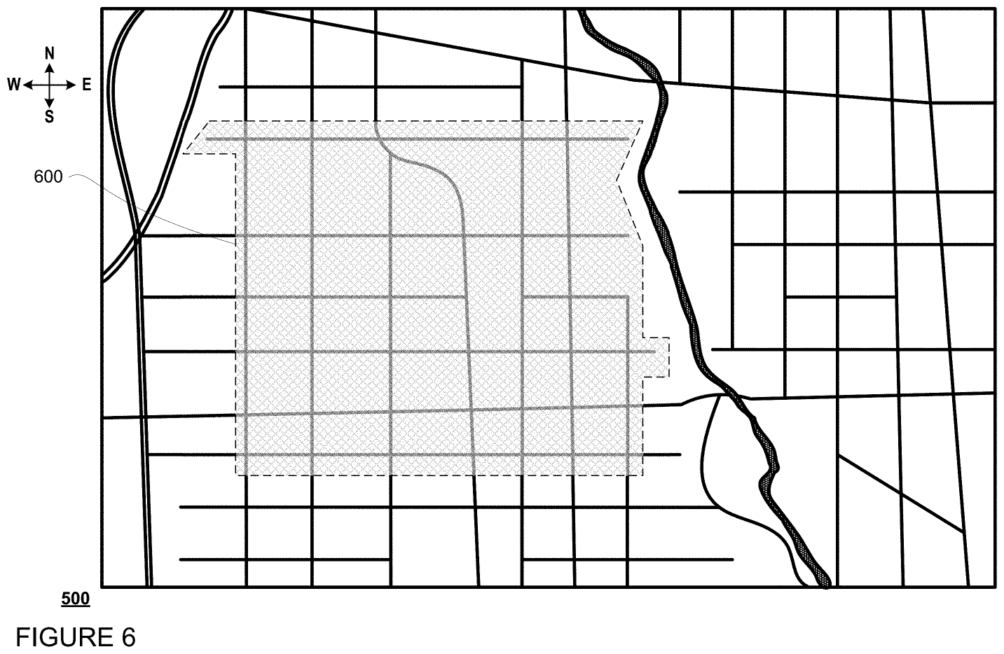

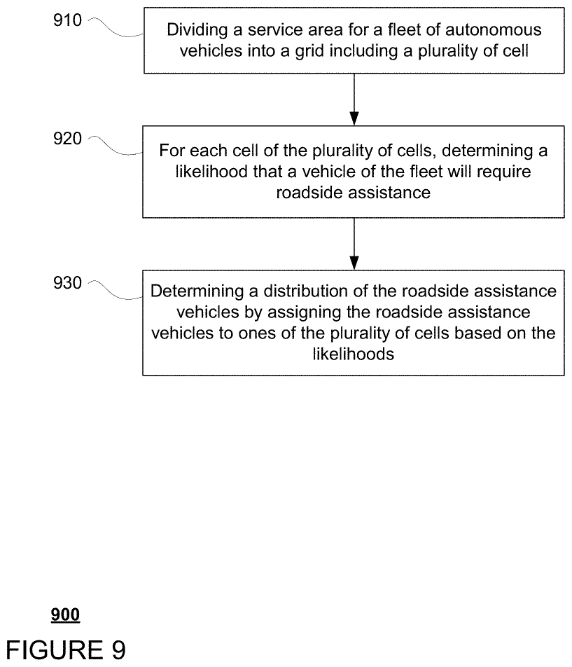

To address these deficiencies, roadside assistance vehicles may be assigned to predetermined areas. FIG. 9 provides an example flow diagram 900 for determining how to distribute roadside assistance vehicles within a service area for a fleet of autonomous vehicles which may be performed, by example, by one or more processors of one or more server computing devices, such as the processors of the server computing devices 410. At block 910, a service area for a fleet of autonomous vehicles is divided into a grid including a plurality of cells. For instance, a service area, which defines where the autonomous vehicles of the fleet (such as shown in FIGS. 4 and 5) are able to provide transportation services, may be divided into a grid of cells. FIG. 5 provides an example of a roadmap 500 including a plurality of roads and other features. This roadmap may include a plurality of map tiles and/or the map information described above. FIG. 6 provides an example service area 600 which represents a service area of the roadmap where vehicles of the fleet of autonomous vehicles may provide transportation services.

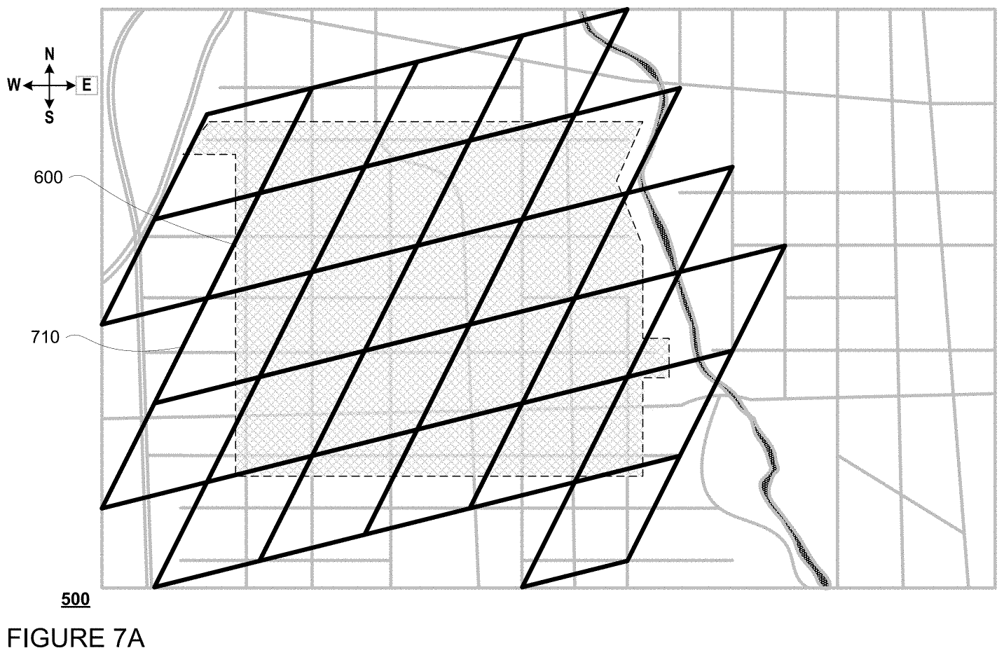

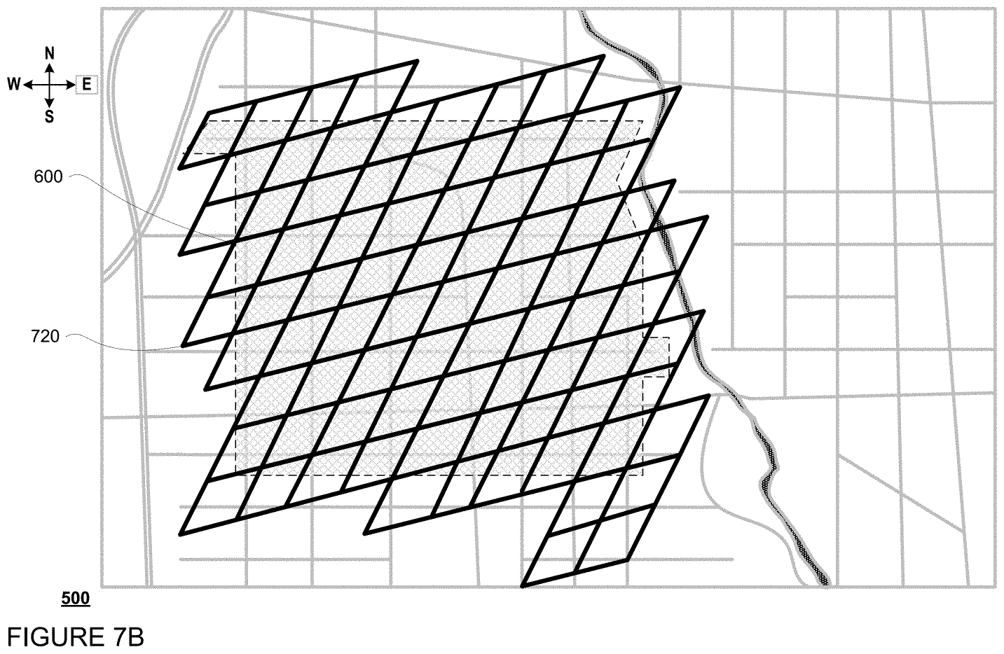

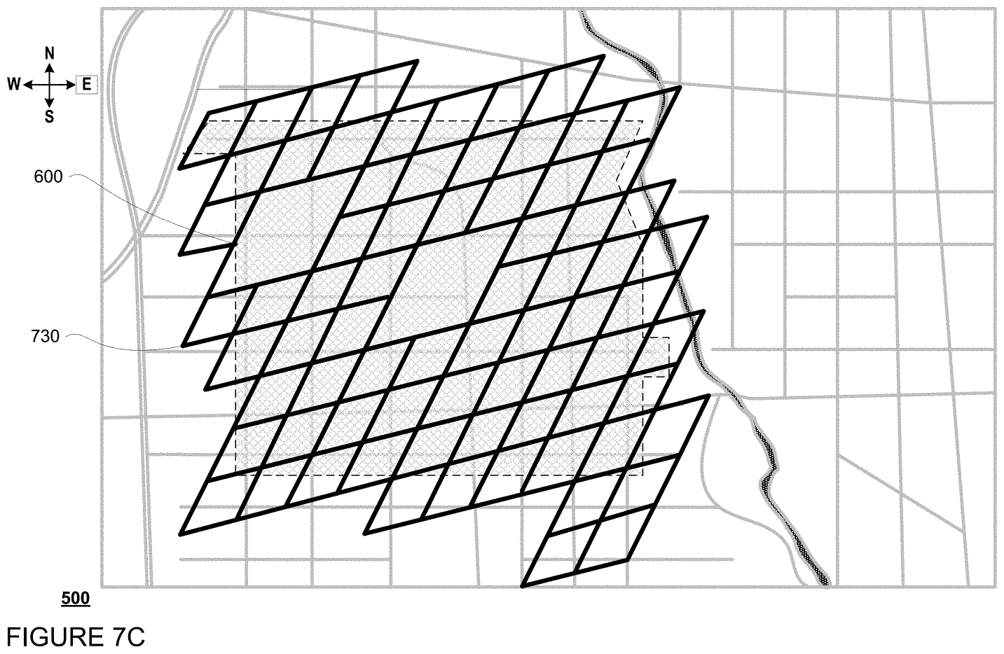

The service area may be divided into a grid of cells, for instance using S2 cells. The S2 cells may be used to represent areas of a curved surface such as the Earth at different levels of granularity (e.g. levels 0 to 30, level 0 having the largest average cell size and level 30 having the smallest average cell size). In this regard, each S2 cell represents a region and corresponding visual representation of that region, e.g. a map tile. The size of S2 cells used may present the tradeoffs between ETA (estimated time of arrival) and operational cost. For instance, the smaller the cell sizes are, the better are the ETAs for the roadside assistance vehicles. FIG. 7A provides an example of a grid 710 of larger cells (i.e. lower S2 level) for the service area 600, while FIG. 7B provides an example of a grid 720 of smaller cells (i.e. higher S2 level) for the service area 600. However, smaller cells may require greater numbers of roadside assistance vehicles and associated human drivers. At the same time, larger cells may be a benefit derived from more advanced autonomous vehicle control software as such vehicles may be less likely to require roadside assistance.

In some instances, the number of cells may be selected according to the number of available roadside assistance vehicles at any given time. In this regard, the cells may be updated in response to the occurrence of an event such as the number of available roadside assistance vehicles changes, the passenger of a period of time or periodically (i.e. at midnight every day), or based on other events, such as new software releases, changes to the map (e.g. road construction or other road changes), etc.

The grid cells may be adjusted based on historical data including where autonomous vehicles are driving or have required assistance over some period of time, such as the last 60 days, last 12 weeks, last 16 weeks, or more or less. For instance, if the number of vehicles of the fleet requiring assistance in the period of time is low in adjacent cells, these cells may be merged together. Similarly, if the autonomous vehicles do not often drive in a particular cell, this cell may be merged with an adjacent cell. As another instance, if a particular cell includes a large number of vehicles requiring assistance and/or a lot of driving, this cell may be divided (e.g. in half or in quarters) into smaller cells. In this regard, the grid may be a hybrid of differently sized cells. FIG. 7C provides an example of a grid 730 of differently sized cells (i.e. different S2 level) for the service area 600.

Returning to FIG. 9, at block 920, for each cell of the plurality of cells, a likelihood that a vehicle of the fleet will require roadside assistance is determined. In other words, each cell, the need for roadside assistance may be predicted by the server computing devices 410. This “need” may correspond to a likelihood that one or more vehicles will require assistance at any given point in time in each cell. This likelihood may be determined using a model such as a Poisson Distribution based model or a logistic regression model. The model may be trained by the server computing devices 410 or other computing devices using input from miles driven by the autonomous vehicles of the fleet or over some period of time, such as the last 60 days, the last 12 weeks, the last 16 weeks or more or less, that include both examples of vehicles requiring assistance and vehicles not requiring assistance. As noted above, this information may be tracked over time and stored in the storage system 450 for access by the server computing devices 410. The training may provide model parameter values for the model which can be used to make predictions about likelihoods of one or more vehicles requiring assistance in a given cell.

In order to make the model useful for areas where vehicles have not previously visited, the training inputs may include, for example, map information (e.g. the physical characteristics of drivable areas as well as other information such as road topography like whether there are mostly 1-way lanes, overlap of public transit e.g. train lines, pedestrian pathways density), traffic information (e.g. the density of vehicles), time of day, weather conditions, as well as other information describing the driving environment in the miles driven. In this regard, for each example of a vehicle requiring assistance or a vehicle not requiring assistance used as training output, the model is provided with the context in which the vehicle was driving. As a result, when map information, traffic information (actual or estimated) time of day (e.g. hour, range of hours corresponding to a particular shift, etc.), weather conditions (actual or estimated), for a particular cell (such as the cells of the grids 710, 720, 730) is input into the model, the model may provide an estimation of how likely one or more vehicles is to require assistance within that cell. The more miles driven and examples of vehicles requiring assistance available under different combinations of traffic, time of day, and weather conditions the more useful the model may be. The examples or events can be further filtered to limit only to driving miles which resulted in vehicles requiring assistance. In other examples, the data may be segmented to provide information about different times, such as a current likelihood of one or more vehicles requiring assistance versus a likelihood of one or more vehicles requiring assistance at some point in time in the future.

In other words, the model may predict how likely one or more vehicles of the fleet is to require assistance under various conditions (e.g. different traffic conditions, times of day, weather, etc.) in a given cell. For a given set of cells, the output of the model may include a likelihood of one or more vehicles requiring assistance for each cell. In this regard, the model may output a value for each of the cells of the grids 710, 720, 730. These cells may even be ordered into a list of increased likelihood of one or more vehicles requiring assistance. This prediction may be used to drive the optimal distribution and placement of roadside assistance vehicles in order to enable the roadside assistance vehicles to assist the autonomous vehicles with predictable arrival and service time while also reducing costs (e.g. less roadside assistance vehicles may be required).

Returning to FIG. 9, at block 930, a distribution of roadside assistance vehicles is determined by assigning the roadside assistance vehicles to ones of the plurality of cells based on the likelihoods. In other words, likelihood of one or more vehicles requiring assistance for each cell may then be used by the server computing devices 410 to distribute roadside assistance vehicles. For instance, available roadside assistance vehicles may be assigned to specific cells of the grid (such as any of grids 710, 720, 730) based on the likelihood of one or more vehicles requiring assistance in each cell such that more roadside assistance vehicles are assigned to cells with higher likelihoods of one or more vehicles requiring assistance. In addition, these assignments can be adjusted over time as the cells and/or likelihoods of one or more vehicles requiring assistance are updated or as other conditions change. For example, at the start of service time, the roadside assistance vehicles will be placed “optimally” in each cell. In circumstances where all of the roadside assistance vehicles may have similar capabilities, the assignments can be random. In other situations where capabilities are different, such as where some remote assistance vehicles are equipped to rescue stranded autonomous vehicles only while other remote assistance vehicles can also have the additional capacity to transport riders from vehicles that require assistance to their final destination (e.g. more space for riders, car seats etc). In such situations, there could be further operational optimization in matching autonomous vehicles with roadside assistance vehicles with the desired capabilities. Thereafter the assignments can be updated and tracked as needed.

In some instances, the distribution may rely on a combination of the likelihood of one or more vehicles requiring assistance as well as the amount of time vehicles have spent driving over some prior period of time. For example, the server computing devices may analyze the last 60 days, 12 weeks, 16 weeks or more or less of driving data for the fleet of vehicles to determine the amount of time spent by vehicles in each cell. This may be multiplied by the likelihood of one or more vehicles requiring assistance to predict a number of vehicles that are likely to require assistance. In some instances, the likelihood of one or more vehicles requiring assistance may be specific to a certain day of the week and/or time of the day. In that regard, the driving data may also be limited to the same day of the week and/or time of day to give an estimation of the number of vehicles that are likely to require assistance. As an example, the day of the week and/or time of day may be selected based on the current day of week and/or time of day, a particular combination of these for a particular shift, and so on. As this number of vehicles increases for a particular cell, the number of roadside assistance vehicles assigned to that cell would also increase. In this regard, if there are zero or 1 vehicle likely to require assistance in a particular cell, only a single vehicle may be assigned to that cell. If there are 2 or more vehicles likely to require assistance in a particular cell, two or more vehicles may be assigned to that cell. Of course, the number of roadside assistance vehicles assigned to the cells will be limited by the number of roadside assistance vehicles available at any given time.

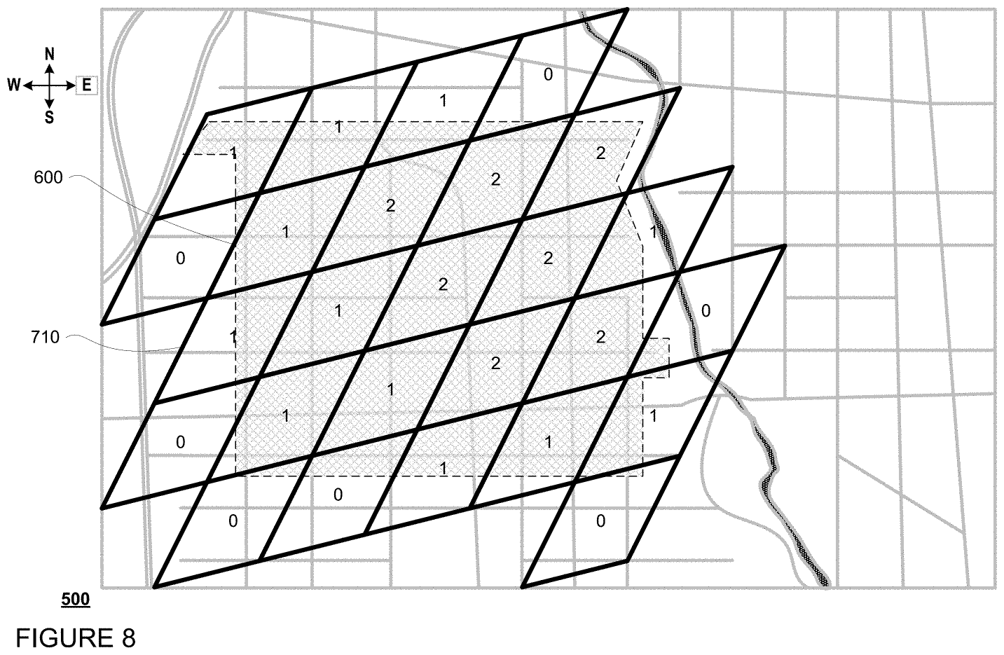

FIG. 8 provides an example of the number of roadside assistance vehicles that may be assigned to particular cells of the grid 710 of FIG. 7A. In this example, 7 cells have no roadside assistance vehicles assigned to them, for instance because no requests for assistance occurred in these cells or the likelihood of such requests for assistance is very low or close to zero. Another 12 cells have only 1 roadside assistance vehicle assigned because the number requests for assistance occurred in these cells or the likelihood of such requests for assistance is relatively moderate, and another 7 cells have 2 vehicles assigned because the number requests for assistance occurred in these cells or the likelihood of such requests for assistance is relatively high. Again the distributions of roadside assistance vehicles will depend not only on these values, but also on the number of roadside assistance vehicles available.

In addition to assigning roadside assistance vehicles to specific cells, another level of optimization may involve the exact placement of the roadside assistance vehicles in a cell. In one example, a roadside assistance vehicle may be assigned to a strategic location or point of interest such as a geographic or traffic midpoint of a cell. This may be defined as the location from which all other locations within the cell can be reached quickest, and may be determined using the average time for arrival. As another example, a roadside assistance vehicle may be assigned to a random or any point within a cell. As another example, a roadside assistance vehicle may be assigned to a location within a cell having the highest likelihood of one or more vehicles requiring assistance. In each example, the roadside assistance vehicle may be asked to wait at the location or drive around the location. In this regard, the roadside assistance vehicle may be stationary or moving, and thus, the aforementioned simulations may be run with the assumption that the roadside assistance vehicle is initially stationary and/or initially moving.

As noted above, in some instances, more than one roadside assistance vehicle may be assigned to a particular cell (e.g. 2 or more vehicles assigned to a single cell). In such cases, roadside assistance vehicles may be assigned as described above but may also be assigned to be positioned in opposite directions. In addition, where there are multiple roadside assistance vehicles assigned to a cell, one or more may be stationary and one or more may be moving. This may be determined based on traffic conditions for that cell. For example, in a high traffic area with fast moving vehicles where entering and exiting traffic pose a challenge, the additional roadside assistance vehicle may be moving or stationary. A moving roadside assistance vehicle may be better able to reach a particular vehicle that requires assistance more quickly, or rather, reduce ETAs. At the same time, when a roadside assistance vehicle is stationary, the driver may be less distracted by the fast-moving vehicles while trying to control the roadside assistance vehicle. Generally, the driver may have more time to consider the best route or direction to go to reach the particular vehicle that requires assistance. For instance, the driver may have more time to decide whether to make a right turn or a left turn, whether to take a highway, etc., whereas in a moving vehicle, these decisions may be more stressful as they may need to be made before the vehicle passes by a turn, entrance ramp, etc.

Each vehicle of the fleet may constantly report its state to one or more server computing devices, such as the server computing devices 410. In this regard, the one or more server computing devices may constantly monitor the states of these vehicles and track these states in the storage system 450 as discussed above. These reports may be sent periodically via a network, such as network 460, and may include various information about the state of the vehicle, including, for example, the vehicle's location and other telemetry information such as orientation, heading, etc., a current destination, the passenger state of the vehicle, the current gear of the vehicle (e.g. park, drive, reverse), as well as the driving mode or other state of the vehicle (e.g. whether the vehicle is still operating autonomously, etc.). The passenger state may identify whether there are passengers and if the vehicle is “hailable” or can be hailed for another trip. In some instances, the reports may also identify whether a vehicle requires assistance and also the reason why the vehicle requires assistance (e.g. low tire pressure or an emergency stop requested by a passenger). As noted above, for any number of reasons including those discussed above, a vehicle of a fleet of autonomous vehicles, such as vehicle 100, may require assistance. Alternatively, the computing devices 110 may sent a specific request for assistance when the vehicle requires assistance.

The distribution information (e.g. mapping of latitude and longitude coordinates of the cells for remote assistance vehicles as well as hours of operation for those roadside assistance vehicles), the trip information (e.g. ongoing trip information for vehicle of the fleet within the cell), and a notification that a vehicle requires assistance are sent to the human operators or technicians of the roadside assistance vehicles. Once the roadside assistance vehicles are assigned to cells and are driving or stopped within those cells, the roadside assistance vehicles may provide roadside assistance services to vehicles of the fleet as they enter different cells. This may be done automatically through an application or web portal that can be accessed using a mobile computing device of the technician. Once a technician is assigned to a vehicle that requires assistance, the technician must be able to navigate to the vehicle that requires assistance, enter the vehicle, disengage the autonomous driving mode of the vehicle, and control the vehicle manually and/or reengage the autonomous driving mode. In this regard, when the technician has the application open, he or she may receive notifications when a vehicle requires assistance as well as other information, if available, such as live camera feed of the location of and/or of the vehicle that requires assistance. This may assist the technician to perform the assistance safely and efficiently.

For instance, the technician may be required to login to the application and/or otherwise authenticate his or herself. Thereafter, the application may provide notifications (e.g. “You have been assigned to respond to a vehicle”) and information to the technician about the state of assigned vehicles for which the technician can provide roadside assistance. The information may include the reason that a vehicle requires assistance (e.g., a stationary obstacle, low tire pressure, software or hardware issue, pullover initiated by passenger, pullover initiated by a remote computing device), location of the vehicle, details about the location, a route and driving directions from the client computing device's current location to the vehicle, an estimated time of arrival for the client computing device to reach the vehicle, the passenger state of the vehicle (whether there are passengers and if the car can be hailed for another trip, though the default may be “not hailable” when a vehicle requires assistance), the current gear of the vehicle (e.g. park, drive, reverse), as well as the driving mode or other state of the vehicle (e.g. whether the vehicle is still operating autonomously, etc.), as well as instructions for actions to take upon arrival at the vehicle.

This information may be provided to the client computing device 420 by the one or more server computing devices 410 as push notifications. In some instances, the volume of alerts for the notifications (e.g. a voice message, a tone, a jingle, or other audible alert) played at the client computing device may increase as the urgency of the notifications increases. Alternatively, the notifications may be more of a constant stream of data from the server computing devices to the client computing device. Information about a vehicle that requires assistance may be tracked by the one or more server computing devices based on periodic state reports from the vehicle (e.g. before, during and after the need for assistance arises).

In some instances, as soon as a vehicle of the fleet enters a cell, the corresponding available roadside assistance vehicle in that zone may be assigned or bound to the vehicle for the duration of the trip or travel time of the vehicle within the cell. That is, this assignment may be made automatically, before or regardless of whether the vehicle of the fleet requires assistance. This may guarantee that the vehicle always has a roadside assistance vehicle assigned to it, when needed. The binding may be updated as the vehicle moves through different cells. In case of multiple vehicles of the fleet for a single roadside assistance vehicle, the binding may evolve from 1:1 to 1:n or in other words such that more than one roadside assistance vehicle is bound to more than one autonomous vehicle in the zone). Alternatively, roadside assistance vehicles may be assigned in order to provide the fastest service arrival time (i.e. SLA) as soon as the need is detected from the autonomous vehicle. This may provide maximum flexibility in terms of availability of roadside assistance vehicles because the roadside assistance vehicle is not ‘tied or bound’ unless it is.

In some instances, if a roadside assistance vehicle is assisting a particular autonomous vehicle and a second autonomous vehicle also requires assistance, a roadside assistance vehicle from a nearby cell may be assigned to a cell currently experiencing multiple requests for assistance. In addition or alternatively, one of a backup reserve fleet of roadside assistance vehicles at one or more centralized locations may be dispatched to the nearby cell (to fill-in) or to the second vehicle depending upon which will have the best SLA. In addition or alternatively, if there are a large number of requests for assistance, the cells may be reconfigured and roadside assistance vehicles reassigned to cells in order to reduce the likelihood of service degradation including operation restrictions or shutting down the service to handle the requests for assistance. Any of the above may also be utilized if a roadside assistance vehicle itself becomes in need of assistance.

The technology relates to optimizing the distribution of roadside assistance vehicles for responding to requests for assistance by autonomous vehicles. The features described herein may provide a more predictable, resilient, scalable, and cost-effective distribution of roadside assistance vehicles without compromising safety. In addition, the model may enable the distribution to be dynamic and adjustable depending upon the number of available roadside assistance vehicles and how likely autonomous vehicles are to require assistance at any given location within a service area.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of determining how to distribute roadside assistance vehicles within a service area for a fleet of autonomous vehicles, the method comprising:
dividing, by one or more processors, the service area into a grid including a plurality of cells;
for each cell of the plurality of cells, determining, by the one or more processors, a likelihood that a vehicle of the fleet will require roadside assistance; and
determining, by the one or more processors, a distribution of the roadside assistance vehicles by assigning the roadside assistance vehicles to ones of the plurality of cells based on the likelihoods.

2. The method of claim 1, wherein dividing the service area into the grid includes using S2 cells.

3. The method of claim 2, further comprising selecting a level of the S2 cells based on a number of the roadside assistance vehicles.

4. The method of claim 1, wherein each cell of the plurality of cells has a same size.

5. The method of claim 1, wherein the plurality of cells includes two or more cells of different sizes.

6. The method of claim 1, further comprising, merging adjacent cells of the grid into a larger cell based on historical data identifying where autonomous vehicles have previously required assistance.

7. The method of claim 1, further comprising, dividing a cell of the grid into two or more smaller cells based on historical data identifying where autonomous vehicles have previously required assistance.

8. The method of claim 1, further comprising, in response to an occurrence of an event:
dividing, by one or more processors, the service area into a second grid including a second plurality of cells;
for each cell of the second plurality of cells, determining, by the one or more processors, a second likelihood that a vehicle of the fleet will require roadside assistance; and
determining, by the one or more processors, a second distribution of the roadside assistance vehicles by assigning the roadside assistance vehicles to ones of the second plurality of cells based on the second likelihoods.

9. The method of claim 8, wherein the event is one or more vehicles of the fleet receiving a software update.

10. The method of claim 8, wherein the event is a change to map information, wherein the map information is further used to determine the likelihoods and the second likelihoods.

11. The method of claim 1, wherein determining the likelihoods includes using a model to predict the likelihoods.

12. The method of claim 11, wherein determining the likelihoods includes inputting map information for each cell into the model.

13. The method of claim 11, wherein determining the likelihoods includes inputting traffic information for each cell into the model.

14. The method of claim 11, wherein determining the likelihoods includes inputting time of day information into the model.

15. The method of claim 1, wherein determining the likelihoods is based on miles driven by autonomous vehicles within a predetermined period of time.

16. The method of claim 1, wherein determining the distribution includes assigning the roadside assistance vehicles to the plurality of cells in order of those having the highest likelihoods.

17. The method of claim 1, further comprising, in response to occurrence of an event:
for each cell of the plurality of cells, determining, by the one or more processors, an updated likelihood that a vehicle of the fleet will require roadside assistance; and
determining an updated distribution of the roadside assistance vehicles by assigning the roadside assistance vehicles to ones of the plurality of cells based on the updated likelihoods.

18. The method of claim 1, wherein assigning the roadside assistance vehicles to ones of the plurality of cells based on the likelihoods includes determining strategic locations within the ones, where a strategic location is one from which all other locations within a cell can be reached by a roadside assistance vehicle quickest.

19. The method of claim 1, further comprising, as an autonomous vehicle of the fleet enters a cell of the plurality of cells, binding a roadside assistance vehicle assigned to that cell to the vehicle such that the roadside assistance vehicle will provide assistance if the autonomous vehicle requests roadside assistance.

20. The method of claim 1, further comprising, when an autonomous vehicle of the fleet requests assistance within a cell of the plurality of cells, binding the roadside assistance vehicle assigned to that cell to the vehicle such that the roadside assistance vehicle will provide roadside assistance to the autonomous vehicle.
